(19) United States
(12) Patent Application Publication
(10) Pub. No.: US 2026/0263857 A1
(43) Pub. Date: Sep. 10, 2026

(54) METHOD FOR REMOVING PFAS COMPRISED IN WASTE

(71) Applicant: SARP INDUSTRIES, LIMAY (FR)

(72) Inventors: Alexis CORBIN, LIMAY (FR); Bruno GILARDIN, LIMAY (FR); Xavier CHAUCHERIE, LIMAY (FR); Thierry GOSSET, LIMAY (FR)

(73) Assignee: SARP INDUSTRIES, LIMAY (FR)

(21) Appl. No.: 19/163,432

(22) PCT Filed: Mar. 8, 2024
(86) PCT No.: PCT/FR2024/050285

§ 371 Date: Sep. 9, 2025

(30) Foreign Application Priority Data
Mar. 10, 2023 (FR) FR2302257

(51) Int. Cl. A62D 3/40; A62D 101/22; B01D 53/68; B01D 53/83; B09C 1/06

(52) U.S. Cl. CPC A62D 3/40; B01D 53/685; B01D 53/83; A62D 2101/22; B01D 2251/402; B01D 2251/404; B01D 2257/2047; B01D 2258/0283; B09C 1/06

(57) ABSTRACT

An industrial method for the efficient removal of a poly- and perfluoroalkyl (PFAS) substance, in particular persistent organic pollutants (PFAS POPs), from waste while allowing efficient control of the HF emissions induced by this removal. The method uses a composition including an alkaline earth metal salt to remove the PFAS substance.

### FIELD

This disclosure relates to the field of disposal of poly- and perfluoroalkyl substances (hereinafter denoted PFAS), particularly those contained in waste.

PFAS are a large family of several thousand synthetic chemicals that have been widely used since the 1950s for their non-stick properties, impermeability, and durability under extreme conditions (high heat, high pressure, and/or radiation).

According to a Feb. 7, 2023 presentation by the European Chemicals Agency (hereinafter referred to as ECHA), PFAS are present in numerous applications. For example, PFAS are used in various industrial processes, in the energy sector, in the oil and mining sectors, in the transportation sector, in the surface treatment of materials (waterproofing, water-repellent, anti-wetting), in fire-fighting foams, in lubricants, in electronic products, and in semiconductors. PFAS are also present in everyday objects, such as waterproof clothing (shoes, gloves, coats), non-stick pans, water-repellent stain-resistant textiles (upholstery, carpets), implantable medical devices, cosmetics, medicines, crop protection products, and food packaging. Thus, according to that presentation, approximately 92,000 metric tons of PFAS were used in 2020.

However, PFAS are particularly toxic, even at very low doses. Indeed, according to the ECHA, PFAS are suspected of having multiple harmful effects in humans, such as cancer, reduced fertility, poor fetal development, and interference with the immune system.

Furthermore, due to their chemical structure consisting of carbon-fluorine bonds, which are among the strongest chemical bonds in organic chemistry, PFAS do not degrade after their use or release into the environment. Some PFAS, such as perfluorooctanoic acid (hereinafter referred to as PFOA), perfluorooctane sulfonic acid (hereinafter referred to as PFOS), and perfluorohexane sulfonic acid (hereinafter referred to as PFHxS), are even referred to as “persistent organic pollutants” (hereinafter referred to as PFAS POPs). According to the European Commission, a POP is a chemical compound that persists in the environment, bioaccumulates in the food web, and may have adverse effects on human health and the environment.

According to ECHA, most PFAS are also easily transported in the environment over long distances, far from their source of emission. Contamination of groundwater, surface water, and soil by PFAS has thus frequently been observed. If PFAS continue to be released into the environment, they will continue to accumulate, particularly in drinking water and in food.

PFAS are toxic, polluting, accumulate in the environment, accumulate in drinking water, and accumulate in food. In Europe, their ban is currently under discussion but this is expected to take several years. In the short term, their removal is therefore a major health issue.

### BACKGROUND

On Jul. 27, 2022, the United Nations Environment Program (hereinafter UNEP) issued the technical guide “General technical guidelines on the environmentally sound management of wastes consisting of, containing, or contaminated with persistent organic pollutants,” which provides guidance for the environmentally sound management of wastes consisting of, containing, or contaminated with PFAS POPs. In the present patent application, this technical guide may be referred to as the technical guide issued by UNEP.

The technical guide issued by UNEP defines two efficiencies for quantifying a method's efficiency at removing PFAS POPs. These two efficiencies are:
destruction efficiency (hereinafter referred to as DE). This efficiency corresponds to the percentage of PFAS POPs contained in waste that is destroyed or irreversibly transformed by a particular method or technology, and
destruction and removal efficiency (hereinafter referred to as DRE). This efficiency only takes into account air emissions, and corresponds to the percentage of the original PFAS POPs that were irreversibly transformed and released in the flue gas.

In the field of the invention, there is a consensus on considering a method as efficient when it has a DE greater than or equal to 99.99% and a DRE greater than or equal to 99.9999%.

The publication “PFAS fate and destruction mechanisms during thermal treatment: a comprehensive review, Longendyyke, et al. Environ. Sci.: Processes Impact, 2022, 24, 196” presents various methods for removing PFAS. These methods are incineration, thermal desorption, pyrolysis, gasification, smoldering combustion, and hydrothermal liquefaction.

According to that publication:
thermal desorption and pyrolysis allow reducing the amount of PFAS by 90%,
gasification generates volatile PFAS,
smoldering combustion can only reduce the amount of PFAS by about 80%, and
hydrothermal liquefaction can only reduce the amount of PFOA by 99% and the amount of PFOS by 86%.

A method for removing PFAS by gasification is described in U.S. Pat. No. 11,339,337 B1. Specifically, the waste used in that method is wastewater comprising biosolids and PFAS. The method comprises the following steps:
gasification of wastewater at a temperature between 480° C. and 980° C., to produce a syngas containing the PFAS not removed by gasification. Syngas is a mixture of carbon monoxide (CO) and hydrogen (H₂). Thus, unlike incineration carried out in an oxidizing medium, gasification must unavoidably be carried out in a reducing medium in order to produce syngas;
combustion of the syngas containing the PFAS at a temperature between 870° C. and 1420° C., to produce a flue gas containing the PFAS not removed by combustion;
cooling the flue gas containing the PFAS to a temperature between 205° C. and 650° C., to produce a cooled flue gas containing the PFAS; and
placing the cooled flue gas containing the PFAS in contact with hydrated lime to increase the decomposition of the PFAS in the cooled flue gas.

Thus, as described in the publication “PFAS fate and destruction mechanisms during thermal treatment: a comprehensive review”, Longendyyke, et al. Environ. Sci.: Processes Impact, 2022, 24, 196, the gasification step of the method in U.S. Pat. No. 11,339,337 B1 generates volatile PFAS that must be decomposed in two subsequent steps.

The method of U.S. Pat. No. 11,339,337 B1 therefore does not allow a simple and efficient removal of PFAS.

Therefore, thermal desorption, pyrolysis, gasification, smoldering combustion, and hydrothermal liquefaction do not appear to be able to remove PFAS simply and in a sufficiently efficient manner. Moreover, given the complexity of their implementation and the very large quantity of PFAS to be removed, these methods are difficult to envisage on an industrial scale.

As for incineration, this is a technique that can be envisaged on an industrial scale. Indeed, it is simple to implement and allows treating a very large amount of waste and therefore waste containing PFAS. However, a study presented in that publication concludes that PFOA is not degraded by being subjected to 1000° C. for 2 seconds.

Furthermore, according to that publication, the destruction of PFAS, in particular thermal destruction, generates hydrogen fluoride, hereinafter referred to as HF. HF is an extremely toxic and ecotoxic compound. In addition, HF can damage the incineration unit via its corrosive action on metals or, as explained in that publication, by reacting with the silica-based coating of the reactors to produce silicon tetrafluoride.

During an industrial-scale test, the Applicant subjected waste containing PFAS to a temperature between 962° C. and 979° C. in an incineration unit. It was found that some PFAS could be efficiently removed but, in exchange, HF emissions were higher than the limit value of 1 mg/Nm³ dry at 11% O₂ as indicated in Annex VI of Directive 2010/75/EU of the European Parliament and of the Council of 24 Nov. 2010.

### Technical Problem

A need therefore still exists for an industrial solution that allows efficient removal of PFAS while allowing efficient control of the HF emissions induced by this removal.

It is therefore to the credit of the inventors that they have found it is possible to meet this need by subjecting the waste containing the PFAS to heat treatment in the presence of an alkaline earth metal salt.

### SUMMARY

A method is therefore proposed for removing a poly- and perfluoroalkyl substance included in a waste, the method comprising a step of:
a) heat treating the waste at a temperature greater than or equal to 850° C., in particular between 900° C. and 1100° C., more particularly between 950° C. and 1050° C., step a) being carried out in the presence of a composition comprising an alkaline earth metal salt.

Surprisingly, the combination of the heat treatment carried out under the operating conditions of step a), and the alkaline earth metal salt, advantageously allows:
an efficient and simple removal of the poly- and perfluoroalkyl substance, in particular the following PFAS POPs: PFOA, PFOS and PFHxS; and
controlling the HF concentration in the flue gas generated during step a) so that the HF emissions are below the limit value of 1 mg/Nm³ dry at 11% O₂ as indicated in Annex VI of Directive 2010/75/EU of the European Parliament and of the Council of 24 Nov. 2010.

Without being bound by any theory, the inventors are of the opinion that combining the heat treatment carried out under the operating conditions of step a), with the alkaline earth metal salt, renders the method efficient by:
facilitating the degradation reactions of the poly- and perfluoroalkyl substance present in the waste and/or present in the flue gas generated by combustion of the waste during step a), and
efficiently neutralizing the HF formed by this degradation.

Indeed, under the conditions of step a), the heat treatment enables combustion of the waste, degradation of the poly- and perfluoroalkyl substance, and the very rapid oxidation of the alkaline earth metal salt to alkaline earth metal oxide. The inventors are of the opinion that this oxide could then:
catalyze the degradation reactions of the PFAS, thus accelerating the kinetics of these reactions, and/or
react rapidly with the products of these degradations, in particular with HF. In accordance with Le Chatelier's principle, the degradation reactions of the PFAS would then be thermodynamically favored.

Particularly conclusive results have been obtained with calcium carbonate.

The method of the invention is also simple to implement on an industrial scale to treat a large amount of waste. Indeed, the method of the invention can be implemented in a conventional waste incineration unit, known and understood by a person skilled in the art. In addition, the throughput of a combustion furnace in a conventional incineration unit can reach 15 T/h of waste.

The method of the invention is also economical. Indeed, it does not require a heavy investment in equipment since it can be implemented in a conventional waste incineration unit and because the cost of the composition is low.

Also proposed is the use of a composition comprising an alkaline earth metal salt for removing a poly- and perfluoroalkyl substance from waste.

### BRIEF DESCRIPTION OF THE DRAWING

Other features, details and advantages will become apparent from reading the detailed description below, and from analyzing the attached drawing, in which:

FIG. 1 is a diagram illustrating an incineration unit.

### DETAILED DESCRIPTION

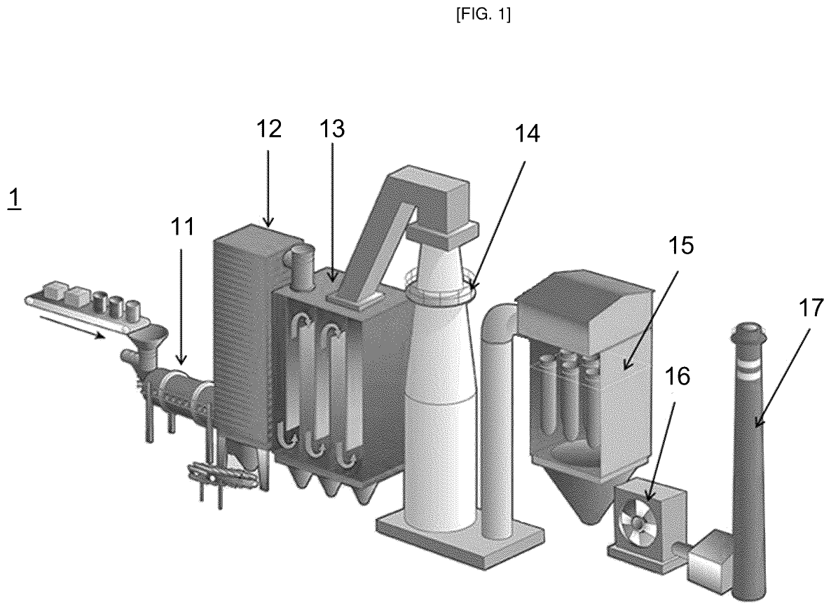

Reference is now made to [FIG. 1].

According to a first aspect, a method is provided for removing a poly- and perfluoroalkyl substance included in a waste, the method comprising a step of:
a) heat treating the waste at a temperature greater than or equal to 850° C., in particular between 900° C. and 1100° C., more particularly between 950° C. and 1050° C.,
step a) being carried out in the presence of a composition comprising an alkaline earth metal salt.

For the purposes of the present invention, the term “poly- and perfluoroalkyl substance” means an organofluorine compound comprising one or more perfluorinated alkyl or polyfluorinated alkyl functional groups.

For the purposes of the present invention, the singular forms “a”, “an”, and “the” also encompass the plural forms of the terms to which they refer, unless the content clearly indicates otherwise.

The poly- and perfluoroalkyl substance used in the method of the present invention may be any PFAS. Thus, the PFAS may be selected among the PFAS presented in Table 45-1 PFAS Target Analytes found in the OTM-45 method of the US EPA in its version of Jan. 13, 2021, the PFAS listed in Directive 2020/2184 of the European Parliament and of the Council of Dec. 16, 2020 relating to the quality of water intended for human consumption, and the combination thereof.

For example, the poly- and perfluoroalkyl substance may be at least one PFAS selected from:

| Common name | Abbreviation | CAS number |
|---|---|---|
| Perfluorooctane sulfonic acid | PFOS | 1763-23-1 |
| Perfluorooctanoic acid | PFOA | 335-67-1 |
| Perfluorohexane sulfonic acid | PFHxS | 355-46-4 |
| Hexafluoropropylene oxide dimer | HFPO-DA | 13252-13-6 |
| acid | (ou GenX) | |
| Perfluorodecane sulfonic acid | PFDS | 335-77-3 |
| Perfluorobutanoic acid | PFBA | 375-22-4 |
| Perfluoropentanoic acid | PFPeA | 2706-90-3 |
| Perfluorohexanoic acid | PFHxA | 307-24-4 |
| Perfluoroheptanoic acid | PFHpA | 375-85-9 |
| Perfluorononanoic acid | PFNA | 375-95-1 |
| Perfluorododecanoic acid | PFDA | 335-76-2 |
| Perfluoroundecanoic acid | PFUnDA | 2058-94-8 |
| Perfluorododecanoic acid | PFDoA | 307-55-1 |
| | (ou PFDoDA) | |
| Perfluorotridecanoic acid | PFTrDA | 72629-94-8 |
| Perfluorotetradecanoic acid | PFTeDA | 376-06-7 |
| Perfluorohexadecanoic acid | PFHxDA | 67905-19-5 |
| Perfluorooctadecanoic acid | PFODA | 16517-11-6 |
| Perfluorobutane sulfonic acid | PFBS | 375-73-5 |
| Perfluoropentane sulfonic acid | PFPeS | 2706-91-4 |
| Perfluoroheptane sulfonic acid | PFHpS | 375-92-8 |
| Perfluorononane sulfonic acid | PFNS | 68259-12-1 |
| Perfluorooctane sulfonic acid | PFDoS | 79780-39-5 |
| Perfluoroundecane sulfonic acid | PFUnDS | 749786-16-1 |
| Perfluorododecane sulfonic acid | PFDoDS | 79780-39-5 |
| Perfluorotridecane sulfonic acid | PFTrS | 791563-89-8 |
| Perfluorooctanesulfonamide | FOSA | 754-91-6 |
| N-Methylperfluorooctanesulfonamide | MeFOSA | 31506-32-8 |
| N-Ethylperfluorooctanesulfonamide | EtFOSA | 4151-50-2 |
| N-Methylperfluorooctanesulfonamido- | N-MeFOSE | 24448-09-7 |
| ethanol | | |
| N-Ethylperfluorooctanesulfonamido- | N-EtFOSE | 1691-99-2 |
| ethanol | | |
| N-Methylperfluorooctanesulfonamido- | MeFOSAA | 2355-31-9 |
| acetic acid | | |
| N-Ethylperfluorooctanesulfonamido- | EtFOSAA | 2991-50-6 |
| acetic acid | | |
| 1H,1H,2H,2H-Perfluorohexane sulfonic | 4:2 FTS | 757124-72-4 |
| acid | | |
| 1H,1H,2H,2H-Perfluorooctane sulfonic | 6:2 FTS | 27619-97-2 |
| acid | | |
| 1H,1H,2H,2H-Perfluorodecane sulfonic | 8:2 FTS | 39108-34-4 |
| acid | | |
| 1H,1H,2H,2H-Perfluorododecane | 10:2 FTS | 120226-60-0 |
| sulfonic acid | | |
| 4,8-Dioxa-3H-perfluorononanoic acid | ADONA | 919005-14-4 |
| 9-Chlorohexadecafluoro-3-oxanonane- | 9Cl-PF3ONS | 756426-58-1 |
| 1-sulfonic acid | | |
| 11-Chloroeicosafluoro-3-oxaundecane- | 11Cl-PF3OUdS | 763051-92-9, |
| 1-sulfonic acid, or Potassium 11- | | or |
| Chloroeicosafluoro-3-oxaundecane- | | 83329-89-9 |
| 1-sulfonate | | |
| Nonafluoro-3,6-dioxaheptanoic acid | NFDHA | 151772-58-6 |
| Perfluoro(2-ethoxyethane)sulfonic acid | PFEESA | 113507-82-7 |
| Sodium perfluorododecanesulfonate | PFDoS | 1260224-54-1 |
| Perfluoro-4-methoxybutanoic acid | PFMBA | 863090-89-5 |
| Perfluoro-3-methoxypropanoic acid | PFMPA | 377-73-1 |
| Decafluoro-4- | PFecHS | 67584-42-3 |
| (pentafluoroethyl)cyclohexanesulfonic | | |
| acid potassium salt | | |
| 2H-Perfluoro-2-decenoic acid | 8:2 FTUCA | 70887-84-2 |
| | (or FOUEA) | |
| 2-Perfluorodecyl ethanoic acid | 10:2 FDEA | 53826-13-4 |
| 2-Perfluorooctyl ethanoic acid | 8:2 FTA | 27854-31-5 |
| | (or FOEA) | |
| 2H-Perfluoro-2-octenoic acid | 6:2 FHUEA | 70887-88-6 |
| 2-Perfluorohexyl ethanoic acid | 6:2 FTCA | 53826-12-3 |
| | (or 6:2 FHEA) | |
| 3:3 Fluorotelomer carboxylic acid | 3:3 FTCA | 356-02-5 |
| 5:3 Fluorotelomer carboxylic acid | 5:3 FTCA | 914637-49-3 |
| 7:3 Fluorotelomer carboxylic acid, or | 7:2 FTCA | 812-70-4 |
| 3-Perfluoropheptylpropanoic acid. | (or FHpPA) | |
| 1H,1H,2H,2H-Perfluoro-1-octanol | 6:2 FTOH | 647-42-7 |
| 1H,1H,2H,2H-Perfluoro-1-decanol | 8:2 FTOH | 678-39-7 |
| Difluoro{[2.2,4,5-tetrafluoro- | C6O4 | 1190931-41-9 |
| 5-(trifluoromethoxy)-1,3-dioxolan-4- | | |
| yl]oxy}acetic acid | | |

According to one embodiment, the PFAS may be selected among the PFAS POPs. Examples are PFOS, PFOA, and PFHxS.

Thus, according to one embodiment, the PFAS may be PFOS, PFOA, PFHxS, a mixture of PFOS and PFOA, a mixture of PFOS and PFHxS, a mixture of PFOA and PFHxS, or a mixture of PFOS, PFOA, and PFHxS.

The method of the invention therefore allows efficient removal of PFAS POPs and thus allows solving a major health problem.

According to another embodiment, the poly- and perfluoroalkyl substance may be selected among PFOS, PFOA, PFHxS, HFPO-DA, PFDS, PFBA, and mixtures thereof.

The waste used in the method of the invention may be any type of waste comprising one or more PFAS. In particular, the waste may comprise at least 0.01 mg of PFAS per kg of waste, in particular from 0.10 mg of PFAS to 1000 mg of PFAS per kg of waste, more particularly from 0.90 mg of PFAS to 150 mg of PFAS per kg of waste.

The waste may be selected among hazardous waste, non-hazardous waste, POP waste, municipal sludge, industrial sludge, and mixtures thereof, in particular hazardous waste, POP waste, and mixtures thereof, more particularly POP waste.

For the purposes of this invention, “non-hazardous waste” means any waste that does not have any of the properties that render the waste hazardous.

For the purposes of this invention, “hazardous waste” means any waste that exhibits one or more of the hazardous properties listed in Annex III to Directive 2008/98/EC of the European Parliament and of the Council of 19 Nov. 2008 concerning waste and the repealing of certain Directives.

For the purposes of this invention, “POP waste” means any waste containing at least 50 mg of PFOS per kg of waste, at least 1 mg of PFOA per kg of waste, and/or at least 1 mg of PFHxS per kg of waste.

For example, non-hazardous waste that may be used in the method of the invention is an everyday object such as waterproof clothing, a non-stick pan, a water-repellent stain-resistant textile, an implantable medical device, a cosmetic product, food packaging, an electronic product, a semiconductor, and combinations thereof. The waterproof clothing may be a shoe, a glove, a coat, or combinations thereof. The water-repellent stain-resistant textile may be upholstery, a carpet, or combinations thereof.

A hazardous waste that may be used in the method of the invention may, for example, be a crop protection product, a lubricant, a paint, a used oil, a used acid, a used solvent, a paint sludge, a fuel tank bottom, an expired pesticide, toxic gas waste, and mixtures thereof.

The POP waste that may be used in the method of the invention may be contaminated soil from an industrial site, in particular from an industrial site where fire-extinguishing powder is manufactured.

The alkaline earth metal salt of the composition may comprise a cation selected among a magnesium cation, a calcium cation, and mixtures thereof; preferably it may be the calcium cation.

The anion of the alkaline earth metal salt may be selected among an acetate, an acrylate, a carbonate, a formate, a propionate, and mixtures thereof, in particular among an acetate, an acrylate, a carbonate, and mixtures thereof; more particularly, the anion is a carbonate.

The alkaline earth metal salt may be selected among a magnesium salt, a calcium salt, or a mixture thereof, in particular among magnesium carbonate, calcium carbonate, or a mixture thereof; more particularly it may be calcium carbonate.

Advantageously, particularly convincing results have been obtained with calcium carbonate. In addition, the cost of calcium carbonate is advantageously low.

Calcium carbonate may be derived from chalk, limestone, lime, shells, mineral sludge, or mixtures thereof, particularly lime, shells, mineral sludge, or mixtures thereof, in particular lime.

The mineral sludge may be composed mainly of calcium carbonate and may, if necessary, be transformed into a powder composition by means of one or more suitable chemical treatments. The chemical treatments are those known to those skilled in the art, for example such as washing, drying, and physicochemical treatments. Carbonate removal sludge, primary brine purification sludge, and a mixture thereof, are mineral sludges that are suitable for use in the method of the invention.

Carbonate removal sludge is a non-hazardous waste typically generated during the operation of removing carbonate from water, an operation carried out at industrial sites requiring supplies of softened water. Each of these sites can generate 1,000 to 3,000 metric tons/year of carbonate removal sludge. Advantageously, using carbonate removal sludge as a source of calcium carbonate therefore allows recycling waste that is not currently recycled and creating a circular economy through the availability of this waste around incinerators. This also allows substituting waste for a natural resource (chalk, limestone, and lime). Carbonate removal sludge generally comprises approximately 65% calcium carbonate, with the remainder being water. To be used in step a) of the method of the invention, it can therefore be dried so that the mass concentration of calcium carbonate in the dried sludge is greater than 90.0%.

Primary brine sewage sludge is a waste resulting from electrolysis during the manufacture of chlorine. It contains carbonates of calcium and magnesium as well as traces of pollutants, salts, and possibly metals. The pollutants, salts, and any metals may be separated by specific operations known to those skilled in the art, such as successive washings or physicochemical treatments. Water can be removed by drying.

The composition may comprise at least 30% by weight of alkaline earth metal salt, in particular between 35% and 100% by weight of alkaline earth metal salt, more particularly between 50% and 99%.

The composition may, for example, be selected among a powder composition, a slurry, and a combination thereof.

For the purposes of this invention, the term “powder composition” is understood to mean a composition in powder form. In particular, the maximum diameter at 50% in the volume distribution of the particles (d50) of the powder composition according to the invention may be less than or equal to 50 μm, preferably between 2 μm and 20 μm, more preferably between 4 μm and 10 μm. The d50 value may be determined by laser particle size analysis in distilled water, using a Malvern-Mastersizer 2000 laser particle size analyzer equipped with a 120 ml “small volume” cell; the signal is processed using the Mie mathematical model.

Advantageously, a particle size in the above ranges allows increasing the contact surface area of the powder composition with the waste and the flue gas generated by heat treating the waste. This allows improving the efficiency of the PFAS removal and improves the efficiency in controlling the HF emissions induced by this removal.

The powder composition may comprise at least 90% by weight of alkaline earth metal salt, in particular at least 95% by weight of alkaline earth metal salt.

According to one particular embodiment, the powder composition is essentially composed of alkaline earth metal salt.

For the purposes of this invention, “essentially composed of” means that other specific elements may be present in the composition, in this case elements that do not have a material impact on the essential characteristics of the composition. Impurities are examples of elements that do not have a material impact on the essential characteristics of the composition.

For the purposes of the invention, the term “slurry” is understood to mean a viscous mixture of a solid material suspended in a liquid, in particular in water, the solid material comprising the alkaline earth metal salt. For example, the slurry may be a suspension of a mineral slurry as described above.

The slurry may comprise at least 30% by mass of alkaline earth metal salt, in particular between 35% and 50% by mass of alkaline earth metal salt.

During step a) of the method of the invention, the heat treatment may be carried out for at least 2 seconds, in particular between 2 seconds and 30 seconds, more particularly between 2.2 seconds and 5 seconds.

This duration corresponds to the duration during which, during step a), the waste is subjected to a temperature greater than or equal to 850° C., in particular between 900° C. and 1100° C., more particularly between 950° C. and 1050° C.

Advantageously, the inventors have noted that the removal of PFAS and the control of HF emissions induced by this removal are all the more efficient when the heat treatment of step a) of the method of the invention is implemented within these duration ranges.

Furthermore, such duration ranges are consistent with implementing the method of the invention in a conventional waste incineration unit 1. Indeed, certain units of a conventional waste incineration unit 1 operate:
at temperatures compatible with the operating conditions of step a) of the method of the invention, and
with dwell times compatible with these duration ranges.

As is schematically shown in [FIG. 1], an incineration unit 1 may comprise, in the direction of flow, a combustion furnace 11, for example a rotary furnace, a flue gas post-combustion chamber 12, a flue gas cooling unit comprising a boiler 13 then a cooling tower 14, a flue gas filtration unit 15, a flue gas ventilation and extraction unit 16, and a stack 17.

The waste is conventionally burned in the combustion furnace 11, thus generating flue gas. This flue gas is then sent to the post-combustion chamber 12 to be burned during a post-combustion step. The burned flue gas from the post-combustion chamber 12 is then cooled and purified in the boiler 13 and the cooling tower 14, then purified in the flue gas filtration unit 15. This purified flue gas is then discharged through the stack 17 after passing through the flue gas ventilation and extraction unit 16.

The incineration unit 1 may conventionally produce solid residues and gaseous residues.

For example, the solid residue may be clinker from the post-combustion chamber 12, fly ash from the boiler 13 and/or from the cooling tower 14, ash from the flue gas filtration unit 15, or combinations thereof. The gaseous residue may be the purified flue gas discharged through the stack 17.

The incineration unit 1 may further comprise an acid and/or alkali flue gas scrubber between the flue gas filtration unit 15 and a flue gas ventilation and extraction unit 16. The scrubbing water from this acid and/or alkali flue gas scrubber is a liquid residue produced by the incineration unit 1.

The heat treatment of step a) of the method of the invention may be a step of incineration by oxidation.

Typically, the temperature in the combustion furnace 11 is between 850° C. and 1200° C. and the temperature in the post-combustion chamber 12 is between 900° C. and 1150° C.

Unlike the gasification reaction, the combustion reaction carried out in the combustion furnace 11 and the post-combustion reactions carried out in the post-combustion chamber 12 require the presence of oxygen. Thus, the oxygen content of the burned flue gas from the post-combustion chamber 12 may be between 1% and 10%, in particular between 2% and 9%, more particularly between 4% and 8% by volume relative to the volume of said burned flue gas.

The heat treatment step a) of the method of the invention may be carried out in the combustion furnace 11 and/or in the post-combustion chamber 12 of the incineration unit 1.

Due to their configuration, the combustion furnace 11 and the post-combustion chamber 12 of the incineration unit 1 are not suitable for performing a gasification step producing CO and H₂. Indeed, these two compounds would oxidize immediately with the oxygen in the combustion air, which would be particularly hazardous in the case of H₂.

Indeed, the temperature and/or the partial pressure of the oxygen in the combustion furnace 11 and/or in the post-combustion chamber 12 are such that step a) of the method of the invention may advantageously be carried out therein. Furthermore, with such a step a), it is not necessary to add to the incineration unit 1 a unit specifically dedicated to reducing the HF concentration in the combustion flue gas. Consequently, such a step a) allows not to increase the complexity of the incineration unit 1 but to increase the energy efficiency of the method of the invention.

A heat treatment duration of at least 2 seconds, in particular 2 seconds to 3 seconds, is suitable for carrying out step a) in the post-combustion chamber 12 of the incineration unit 1.

Indeed, advantageously, such a duration is consistent with the conventional dwell time of flue gases in the post-combustion chamber 12 of the incineration unit 1. Such a duration also allows efficient removal of the PFAS and efficient control of the HF emissions induced by this removal.

A heat treatment duration of at least 2 seconds, in particular from 2 seconds to 30 seconds, more particularly from 2.1 seconds to 3 seconds, is suitable for carrying out step a) in the combustion furnace 11.

Indeed, advantageously, such a duration is consistent with the duration during which waste is conventionally subjected to the operating conditions of step a) in the combustion furnace 11, and with the conventional dwell time of flue gases generated by combustion of this waste in the combustion furnace 11. Such a duration also allows efficient removal of the PFAS and efficient control of the HF emissions induced by this removal.

A heat treatment duration of at least 2 seconds, in particular from 2 seconds to 30 seconds, more particularly from 2.2 seconds to 5 seconds, is suitable for carrying out step a) in the combustion furnace 11 and in the post-combustion chamber 12 of the incineration unit 1.

Typically, during step a) of the method of the invention, the composition may be injected into the combustion furnace 11, at the interface between the combustion furnace 11 and the post-combustion chamber 12 and/or into the post-combustion chamber 12.

The powder composition is suitable for injection into the post-combustion chamber 12 and/or at the interface between the combustion furnace 11 and the post-combustion chamber 12.

Due to its particle size, the powder composition has flowability properties that allow for proper injection.

The slurry is suitable for injection into the combustion furnace 11, at the interface between the combustion furnace 11 and the post-combustion chamber 12 and/or into the post-combustion chamber 12, in particular into the combustion furnace 11.

Advantageously, injecting the slurry into the combustion furnace 11, in particular at the inlet to the combustion furnace 11, maximizes the contact time between the waste and the alkaline earth metal salt and therefore increases the efficiency of the PFAS removal and the efficiency of the HF emission control induced by this removal.

The composition may be injected using an injection device such as a volumetric metering screw or a weight metering screw.

A mass flow meter may also be used to control the rate at which the composition is injected the combustion furnace 11, at the interface between the combustion furnace 11 and the post-combustion chamber 12 and/or into the post-combustion chamber 12.

The ratio of the mass of PFAS to the mass of the composition may be between 1:0.01 and 1:0.5, in particular between 1:0.03 and 1:0.25, more particularly between 1:0.06 and 1:0.08.

Advantageously, such a mass ratio allows for efficient removal of PFAS, efficient control of the HF emissions induced by this removal, and does not impair the operation of the incineration unit 1.

This mass ratio may depend on the flow rate of waste in the combustion furnace 11 and the rate of injection of the composition in the combustion furnace 11, at the interface between the combustion furnace 11 and the post-combustion chamber 12 and/or in the post-combustion chamber 12.

The person skilled in the art will know how to adapt these flow rates, in particular the rate of injection of the composition, so as to satisfy this mass ratio. Indeed, it is necessary to know the flow rate of waste in the combustion furnace 11 and the mass flux of PFAS in the waste in order to then determine the rate of injection of the composition.

Typically, the flow rate of waste in the combustion furnace 11 may be greater than 0.1 t/h, in particular between 1.5 t/h and 15 t/h, more particularly between 5 t/h and 10 t/h.

The rate of injection of the composition may be between 10 kg/h and 300 kg/h, in particular between 40 kg/h and 250 kg/h, more particularly between 50 kg/h and 200 kg/h.

According to another aspect, a use of a composition comprising an alkaline earth metal salt to remove a poly- and perfluoroalkyl substance comprised in waste is also provided.

The composition, the poly- and perfluoroalkyl substance, and the waste are as described above in relation to the method of the invention.

For example, this use may be carried out at a temperature that is greater than or equal to 850° C., in particular between 900° C. and 1100° C., more particularly between 950° C. and 1050° C.

Advantageously, the method of the invention can be described as efficient according to the consensus that is in use in the field of the invention. Indeed, for various poly- and perfluoroalkyl substances, in particular PFOS, PFOA, PFHxS, HFPO-DA, PFDS and PFBA, the method of the invention allows obtaining a DRE greater than or equal to 99.9999% and a DE greater than or equal to 99.99%.

In accordance with the technical guide issued by UNEP, in the present application and for each PFAS, the DRE and the DE are calculated according to the following formulas:

$$DRE = \frac{FMD - FMRG}{FMD}$$

$$DE = \frac{FMD - ( FMRG + FMRS + FMRL )}{FMD}$$

where:
FMD is the hourly mass flux (in mg/h) of PFAS in the waste,
FMRG is the hourly mass flux (in mg/h) of PFAS in the gaseous residue,
FMRS is the hourly mass flux (in mg/h) of PFAS in the solid residue, and
FMRL is the hourly mass flux (in mg/h) of PFAS in the liquid residue.

The hourly mass flux of PFAS in the waste is equal to the product of the average mass concentration of PFAS in the waste times the average mass flow rate of the waste, the waste being for example the waste utilized in the combustion furnace 11 in [FIG. 1].

The hourly mass flux of PFAS in the solid residue is equal to the product of the average mass concentration of PFAS in the solid residue times the average mass flow rate of the solid residue, the solid residue being for example the clinker from the post-combustion chamber 12, fly ash from the boiler 13 and/or from the cooling tower 14, ash from the flue gas filtration unit 15, or combinations thereof in [FIG. 1].

The average mass concentration of PFAS in the waste and the average mass concentration of PFAS in the solid residue may be determined by applying the 2020 Method 537M of the US EPA to several samples, for example, six samples, collected from the waste and the solid residue.

The hourly mass flux of PFAS in the gaseous residue is equal to the product of the average emission of PFAS in the gaseous residue (ng/Nm³) and the average volume flow rate of the gaseous residue (Nm³/h), where the gaseous residue is, for example, the flue gas discharged from the stack 17 in [FIG. 1].

The average emission in the gaseous residue may be determined by applying the Jan. 13, 2021 version of the OTM-45 method of the US EPA to several samples, in particular several samples having a volume greater than 3 Nm³ dry, collected from the gaseous residue.

The hourly mass flux of PFAS in the liquid residue is equal to the product of the average mass concentration of PFAS in the liquid residue times the average mass flow rate of the liquid residue, the liquid residue being, for example, flue gas scrubbing water from an acid and/or alkali scrubber.

The average mass concentration of PFAS in the liquid residue may be determined by applying Method 537 dated 2009 of the US EPA to several samples, for example, six samples, collected from the waste and from the liquid residue.

Unless otherwise indicated or in case of obvious incompatibility, the embodiments of the invention described above may be combined with each other.

The invention is described in more detail below, with the aid of the following example which is in no way limiting but is given solely by way of example.

### EXAMPLES

This example describes an industrial-scale test of the method of the invention, conducted in a combustion unit 1 which is an existing industrial hazardous waste incineration line.

The combustion unit 1 used is shown in the diagram in [FIG. 1] and is composed of the following elements:
a rotary combustion furnace 11 with a maximum flow rate of 10 t/h,
a post-combustion chamber 12,
a boiler 13,
a flue gas cooling tower 14,
a flue gas filtration unit 15 comprising two baghouses,
a flue gas ventilation and extraction unit 16, and
a stack 17.

Activated carbon is injected into the two baghouses at a flow rate of 4 kg/h. Lime is injected into the second baghouse, along the direction of flow, at a rate of 175 to 300 kg/h.

For the tests, the powder composition tested was Desulfocarb P2-EC from Omya International AG. It contains more than 97% calcium carbonate by mass and has a d50 value of 8 μm.

The powder composition tested was stored in a silo with a capacity of 20 tons. Injection at the top of the post-combustion chamber 12 was carried out at two diametrically opposite points. This injection was carried out using two metering screws located downstream of a spring balance placed under the silo, allowing the mass flow rates of the injection to be controlled and regulated.

The waste tested was 65 tons of contaminated soil from a French site that formerly produced fire-extinguishing powders. The waste was introduced into the rotary combustion furnace 11 using a grapple operated from the control room of the rotary combustion furnace 11.

Six samples were collected from the contaminated soil. Each sample was analyzed according to the 2020 Method 537M of the US EPA. The average mass concentration of each identified PFAS was then calculated.

As highlighted in Table 1 below, the tested waste was contaminated with PFOS, PFOA, PFHxS, PFDS, PFBA, and HFPO-DA. PFOS, PFOA, and PFHxS are PFAS POPs. Given the average mass concentration of each of these 3 PFAS POPs, the tested waste is POP waste.

TABLE 1

| | PFAS identified | | | | | |
|---|---|---|---|---|---|---|
| | PFOS | PFHxS | PFOA | HFPO-DA | PFDS | PFBA |
| Average mass | 81 | 3.32 | 1.02 | 0.0001 | 0.12 | 0.014 |
| concentration in the | | | | | | |
| tested waste | | | | | | |
| (mg/kg) | | | | | | |

The operating conditions are presented in Table 2 below.

The tested powder composition was not injected into the post-combustion chamber 12 on days 1 and 2.

As shown in Table 2, the average temperature in the post-combustion chamber 12 varied by 17° C. during the four days of testing. This temperature variation, less than 2%, is considered negligible and results from the conventional operation of the rotary combustion furnace 11 and post-combustion chamber 12 and the control over the mixture of waste entering the rotary combustion furnace 11.

The test results are also presented in Table 2 below. Table 2 therefore shows:
the sum of the average mass concentrations of PFAS present in the solid residues (clinker from the post-combustion chamber 12 and in the ash from the two baghouses of the flue gas filtration unit 15). These mass concentrations were determined by applying the 2020 Method 537M of the US EPA to various samples of solid residues over the 4 days of testing,
the average PFAS emissions, measured in various samples of flue gas from the stack 17 by using the Jan. 13, 2021 version of Method OTM-45 of the US EPA, over the 4 days of testing, and
the average HF emissions, measured in the flue gas in various samples from the stack 17 by using the 2007 NFX-43-304 method over the 4 days of testing.

Table 3 presents the calculated DRE values for each of the six PFAS present in the waste.

Table 4 presents the calculated DE values for each of the six PFAS present in the waste.

The DRE and DE of each PFAS are determined using:
the hourly mass flux of each of the six PFAS present in the waste processed in the rotary combustion furnace 11,
the hourly mass flux of each of the six PFAS present in the flue gas from the stack 17, and
the sum of the hourly mass fluxes of each of the six PFAS present in the solid residues (clinker from the post-combustion chamber 12 and in the ash from the two baghouses of the flue gas filtration unit 15).

There is no liquid residue.

Tables 2 to 4 highlight the importance of combining the heat treatment carried out under the operating conditions of step a), and the tested powder composition comprising more than 97% by mass of calcium carbonate.

In particular, Table 2 shows that injecting the tested powder composition into the post-combustion chamber 12 makes it possible to reduce:
PFAS emissions by a factor of 2.3 to 3.7, and
HF emissions by a factor of 2.3 to 3.7 to reach a value of 0.1 mg/Nm³ dry at 11% O₂, i.e. a value well below the limit value of 1 mg/Nm³ dry at 11% O₂ as indicated in Annex VI of Directive 2010/75/EU of the European Parliament and of the Council of 24 Nov. 2010.

Furthermore, according to Tables 3 and 4, on days 1 and 2, during which the tested powder composition is not injected into the post-combustion chamber 12, the removal of PFDS and PFBA is not efficient because the DE of PFDS and the DE of PFBA are less than 99.99% and the DRE of PFBA is less than 99.9999%. On the other hand, during days 3 and 4, during which the tested powder composition is injected into the post-combustion chamber 12, the six PFAS are efficiently removed.

This example therefore demonstrates that the combination of the heat treatment of waste comprising PFAS under the conditions of step a) of the method of the invention, and the powder composition comprising calcium carbonate, allows the efficient removal of the six PFAS while controlling HF emissions so as to comply with the limit value of 1 mg/Nm³ dry at 11% O₂ as indicated in Annex VI of Directive 2010/75/EU of the European Parliament and of the Council of 24 Nov. 2010.

TABLE 2

| | Day 1 | Day 2 | Day 3 | Day 4 |
|---|---|---|---|---|
| Average waste flow rate in 11 (t/h) | 2.1 | 2.3 | 2.2 | 2.9 |
| Average temperature in 12 (° C.) | 962 | 979 | 971 | 968 |
| Dwell time of flue gas from waste | 2.2-2.6 | 2.2-2.6 | 2.2-2.6 | 2.2-2.6 |
| combustion in 12 (seconds) | | | | |
| Rate of injection of powder | / | / | 120 | 160 |
| composition in 12 (kg/h) | | | | |
| Sum of the average mass concen- | 0.39 | 0.33 | 0.23 | 0.48 |
| trations of PFAS present in the | | | | |
| solid residues (clinker from | | | | |
| post-combustion chamber 12 and | | | | |
| in the ash from the two baghouses | | | | |
| of the flue gas filtration unit | | | | |
| 15) (mg/kg). | | | | |
| Average PFAS emissions measured | 88 | 63 | 27 | 24 |
| in the flue gas from the stack | | | | |
| 17 (ng/Nm³ dry at 11% O₂) | | | | |
| Average HF emissions measured | 2.6 | 2.5 | 0.1 | 0.1 |
| in the flue gas from the stack | | | | |
| 17 (mg/Nm³ dry at 11% O₂) | | | | |

TABLE 3

| PFAS | Day 1 | Day 2 | Day 3 | Day 4 |
|---|---|---|---|---|
| PFOS | >99.9999% | >99.9999% | >99.9999% | >99.9999% |
| PFHxS | >99.9999% | >99.9999% | >99.9999% | >99.9999% |
| PFOA | >99.9999% | >99.9999% | >99.9999% | >99.9999% |
| HFPO-DA | >99.9999% | >99.9999% | >99.9999% | >99.9999% |
| PFDS | >99.9999% | >99.9999% | >99.9999% | >99.9999% |
| PFBA | 99.9998% | 99.9997% | >99.9999% | >99.9999% |

TABLE 4

| PFAS | Day 1 | Day 2 | Day 3 | Day 4 |
|---|---|---|---|---|
| PFOS | >99.99% | >99.99% | >99.99% | >99.99% |
| PFHxS | >99.99% | >99.99% | >99.99% | >99.99% |
| PFOA | >99.99% | >99.99% | >99.99% | >99.99% |
| HFPO-DA | >99.99% | >99.99% | >99.99% | >99.99% |
| PFDS | 99.87% | >99.99% | >99.99% | >99.99% |
| PFBA | 99.56% | 99.23% | >99.99% | >99.99% |

1-12. (canceled)

13. A method for removing a poly- and perfluoroalkyl substance from waste, the method comprising a step of:
a) heat treating the waste at a temperature greater than or equal to 850° C.,
step a) being carried out in the presence of a composition comprising an alkaline earth metal salt.

14. The method according to claim 13, wherein the poly- and perfluoroalkyl substance is selected from the group consisting of: PFOS, PFOA, PFHxS, HFPO-DA, PFDS, PFBA, PFPeA, PFHxA, PFHpA, PFNA, PFDA, PFUnDA, PFDoA, PFTIDA, PFTeDA, PFHxDA, PFODA, PFBS, PFPeS, PFHpS, PFNS, PFDOS, PFUnDS, PFDoDS, PFTIDS, FOSA, MeFOSA, EtFOSA, N-MeFOSE, N-EtFOSE, MeFOSAA, EtFOSAA, 4:2 FTS, 6:2 FTS, 8:2 FTS, 10:2 FTS, ADONA, 9C1-PF3ONS, 11Cl-PF3OUdS, NFDHA, PFEESA, PFMBA, PFMPA, PFecHS, 8:2 FTUCA, 10:2 FDEA, 8:2 FTA, 6:2 FHUEA, 6:2 FTCA, 3:3 FTCA, 5:3 FTCA, 7:2 FTCA, PFECHS, 6:2 FTOH, 8:2 FTOH, C6O4, and mixtures thereof.

15. The method according to claim 13, wherein the waste is selected from the group consisting of: hazardous waste, non-hazardous waste, POP waste, municipal sludge, industrial sludge, and mixtures thereof.

16. The method according to claim 13, wherein the composition comprises at least 30% by weight of alkaline earth metal salt.

17. The method according to claim 13, wherein the alkaline earth metal salt is selected from the group consisting of a magnesium salt, a calcium salt, and a mixture thereof.

18. The method according to claim 13, wherein the composition is selected from the group consisting of a powder composition, a slurry, and a combination thereof.

19. The method according to claim 18, wherein the powder composition has a maximum diameter at 50% in a volume distribution of particles (d50) of the powder composition that is less than or equal to 50 μm.

20. The method according to claim 13, wherein the ratio of the mass of the poly- and perfluoroalkyl substance to the mass of the composition is between 1:0.01 and 1:0.5.

21. The method according to claim 13, wherein the heat treatment of step a) is carried out for at least 2 seconds.

22. The method according to claim 13, wherein the step a) of heat treatment is carried out in a combustion furnace, and/or in a post-combustion chamber of an incineration unit.
